(19) United States
(12) Patent Application Publication
(10) Pub. No.: US 2011/0307562 A1
(43) Pub. Date: Dec. 15, 2011

(54) RECOMMENDATION ENGINE FOR EVENT ANALYZER WITH INTEGRATED INFORMATION

(75) Inventors: AL CHAKRA, APEX, NC (US); FENG-WEI CHEN, CARY, NC (US)

(73) Assignee: INTERNATIONAL BUSINESS MACHINES CORPORATION, ARMONK, NY (US)

(21) Appl. No.: 12/815,054

(22) Filed: Jun. 14, 2010

(51) Int. Cl. G06F 15/16

(52) U.S. Cl. 709/206

(57) ABSTRACT

A computer implemented method manages responses to electronic messages. A computer detects a receipt of an electronic message by a recipient. The computer generates a summary of a content of the electronic message. The summary describes a need for a meeting between the recipient and an other party. The computer generates a recommendation for a communication channel for the meeting between the recipient and the other party.

### BACKGROUND

The present disclosure relates to the field of computers, and specifically to electronic messages transmitted between computers. Still more particularly, the present disclosure relates to mining and extrapolating information from electronic messages.

### BRIEF SUMMARY

A computer implemented method manages responses to electronic messages. A computer detects a receipt of an electronic message by a recipient. The computer generates a summary of a content of the electronic message. The summary describes a need for a meeting between the recipient and an other party. The computer generates a recommendation for a communication channel for the meeting between the recipient and the other party

A computer system comprises a central processing unit and a memory coupled to the central processing unit. The memory comprises software that, when executed, causes the central processing unit to implement: detecting a receipt of an electronic message by a recipient; generating a summary of a content of the electronic message, wherein the summary describes a need for a meeting between the recipient and an other party; and generating a recommendation for a communication channel for the meeting between the recipient and the other party.

A computer program product comprises a computer readable storage medium having computer readable program code embodied therewith. The computer readable program code comprises: computer readable program code to detect a receipt of an electronic message by a recipient; computer readable program code to generate a summary of a content of the electronic message, wherein the summary describes a need for a meeting between the recipient and an other party; and computer readable program code to generate a recommendation for a communication channel for the meeting between the recipient and the other party.

### BRIEF DESCRIPTION OF THE SEVERAL VIEWS OF THE DRAWINGS

FIG. 1 depicts an exemplary computer in which the present disclosure may be implemented;

FIG. 2 illustrates an exemplary intelligent event analyzer used to react to received electronic messages;

FIG. 3 depicts an exemplary user interface that utilizes information from the intelligent event analyzer illustrated in FIG. 2, and

FIG. 4 is a high level flow chart of one or more exemplary steps taken by a computer to manage reactions to electronic messages.

### DETAILED DESCRIPTION

As will be appreciated by one skilled in the art, the present disclosure may be embodied as a system, method or computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product embodied in one or more computer-readable medium(s) having computer-readable program code embodied thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber cable, RF, etc., or any suitable combination of the foregoing.

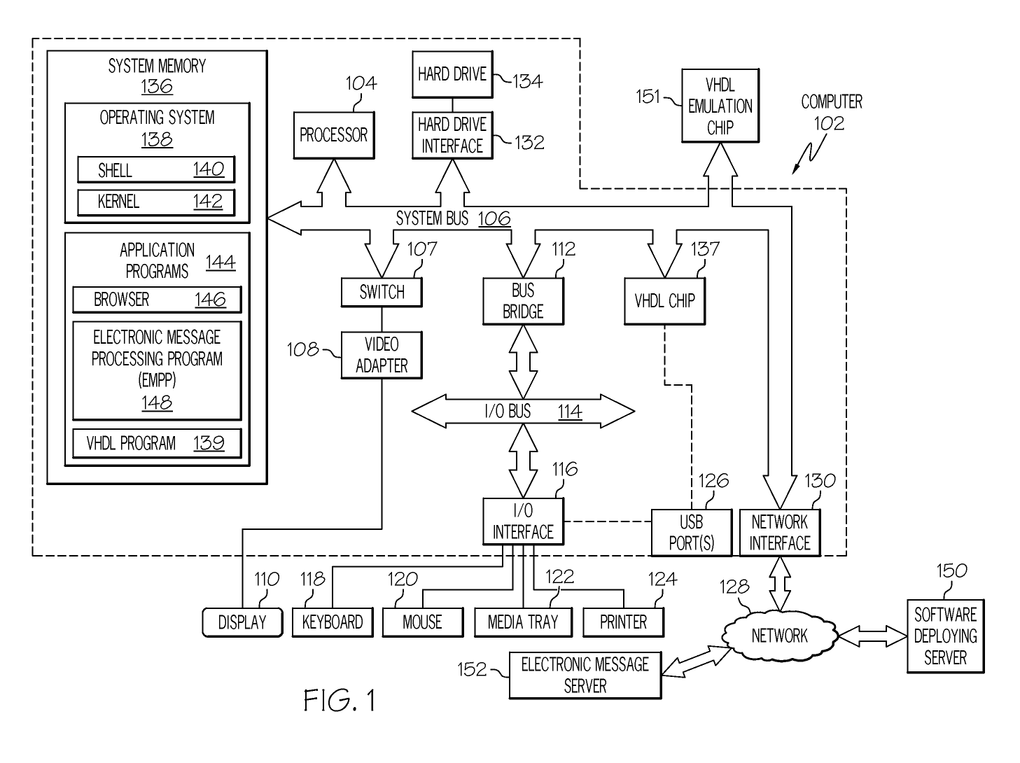

With reference now to the figures, and in particular to FIG. 1, there is depicted a block diagram of an exemplary computer 102, which may be utilized by the present disclosure. Note that some or all of the exemplary architecture, including both depicted hardware and software, shown for and within computer 102 may be utilized by software deploying server 150, and/or an electronic message server 152.

Computer 102 includes a processor unit 104 that is coupled to a system bus 106. Processor unit 104 may utilize one or more processors, each of which has one or more processor cores. A video adapter 108, which drives/supports a display 110, is also coupled to system bus 106. In one embodiment, a switch 107 couples the video adapter 108 to the system bus 106. Alternatively, the switch 107 may couple the video adapter 108 to the display 110. In either embodiment, the switch 107 is a switch, which may be mechanical, that allows the display 110 to be coupled to the system bus 106, and thus to be functional only upon execution of instructions (e.g., electronic message processing program—EMPP 148 described below) that support the processes described herein.

System bus 106 is coupled via a bus bridge 112 to an input/output (I/O) bus 114. An I/O interface 116 is coupled to I/O bus 114. I/O interface 116 affords communication with various I/O devices, including a keyboard 118, a mouse 120, a media tray 122 (which may include storage devices such as CD-ROM drives, multi-media interfaces, etc.), a printer 124, and (if a VHDL chip 137 is not utilized in a manner described below), external USB port(s) 126. While the format of the ports connected to I/O interface 116 may be any known to those skilled in the art of computer architecture, in one embodiment some or all of these ports are universal serial bus (USB) ports.

As depicted, computer 102 is able to communicate with a software deploying server 150 and/or electronic message server 152 via network 128 using a network interface 130. Network 128 may be an external network such as the Internet, or an internal network such as an Ethernet or a virtual private network (VPN).

A hard drive interface 132 is also coupled to system bus 106. Hard drive interface 132 interfaces with a hard drive 134. In one embodiment, hard drive 134 populates a system memory 136, which is also coupled to system bus 106. System memory is defined as a lowest level of volatile memory in computer 102. This volatile memory includes additional higher levels of volatile memory (not shown), including, but not limited to, cache memory, registers and buffers. Data that populates system memory 136 includes computer 102's operating system (OS) 138 and application programs 144.

OS 138 includes a shell 140, for providing transparent user access to resources such as application programs 144. Generally, shell 140 is a program that provides an interpreter and an interface between the user and the operating system. More specifically, shell 140 executes commands that are entered into a command line user interface or from a file. Thus, shell 140, also called a command processor, is generally the highest level of the operating system software hierarchy and serves as a command interpreter. The shell provides a system prompt, interprets commands entered by keyboard, mouse, or other user input media, and sends the interpreted command(s) to the appropriate lower levels of the operating system (e.g., a kernel 142) for processing. Note that while shell 140 is a text-based, line-oriented user interface, the present disclosure will equally well support other user interface modes, such as graphical, voice, gestural, etc.

As depicted, OS 138 also includes kernel 142, which includes lower levels of functionality for OS 138, including providing essential services required by other parts of OS 138 and application programs 144, including memory management, process and task management, disk management, and mouse and keyboard management.

Application programs 144 include a renderer, shown in exemplary manner as a browser 146. Browser 146 includes program modules and instructions enabling a world wide web (WWW) client (i.e., computer 102) to send and receive network messages to the Internet using hypertext transfer protocol (HTTP) messaging, thus enabling communication with software deploying server 150 and other described computer systems.

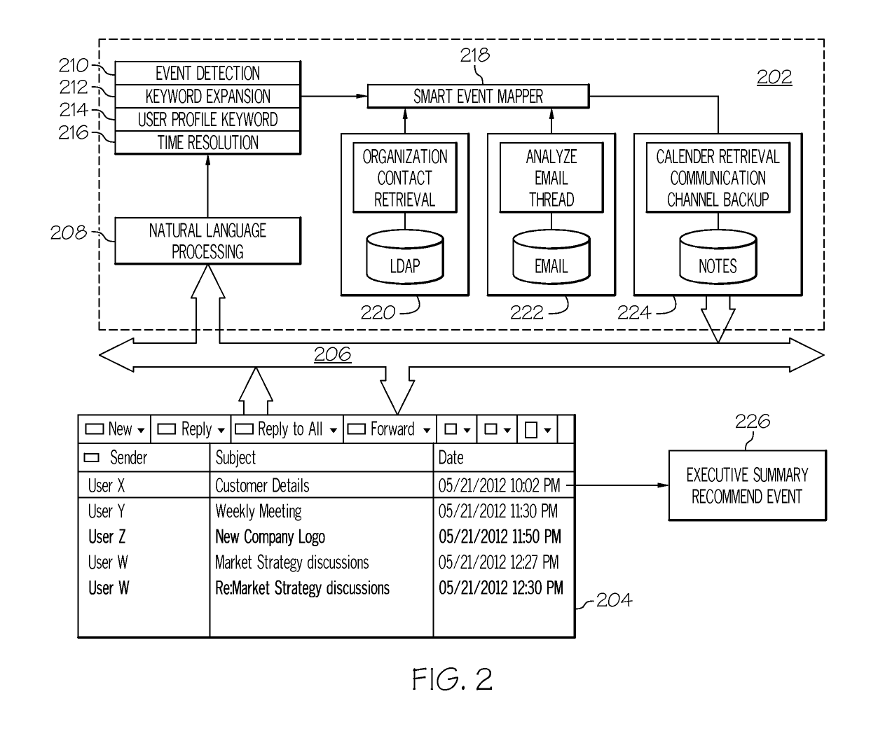

Application programs 144 in computer 102's system memory (as well as software deploying server 150's system memory) also include a electronic message processing program (EMPP) 148. EMPP 148 includes code for implementing the processes described below, including those described in FIGS. 2-4. In one embodiment, computer 102 is able to download EMPP 148 from software deploying server 150, including in an on-demand basis, such that the code from EMPP 148 is not downloaded until runtime or otherwise immediately needed by computer 102. Note further that, in one embodiment of the present disclosure, software deploying server 150 performs all of the functions associated with the present disclosure (including execution of EMPP 148), thus freeing computer 102 from having to use its own internal computing resources to execute EMPP 148.

Also stored in system memory 136 is a VHDL (VHSIC hardware description language) program 139. VHDL is an exemplary design-entry language for field programmable gate arrays (FPGAs), application specific integrated circuits (ASICs), and other similar electronic devices. In one embodiment, execution of instructions from EMPP 148 causes VHDL program 139 to configure VHDL chip 137, which may be an FPGA, ASIC, etc.

In another embodiment of the present disclosure, execution of instructions from EMPP 148 results in a utilization of VHDL program 139 to program a VHDL emulation chip 151. VHDL emulation chip 151 may incorporate a similar architecture as described above for VHDL chip 137. Once EMPP 148 and VHDL program 139 program VHDL emulation chip 151, VHDL emulation chip 151 performs, as hardware, some or all functions described by one or more executions of some or all of the instructions found in EMPP 148. That is, the VHDL emulation chip 151 is a hardware emulation of some or all of the software instructions found in EMPP 148. In one embodiment, VHDL emulation chip 151 is a programmable read only memory (PROM) that, once burned in accordance with instructions from EMPP 148 and VHDL program 139, is permanently transformed into a new circuitry that performs the functions needed to perform the process described below in FIGS. 2-4.

Note that electronic message server 152 is a computer that generates and/or passes on electronic messages, which may be e-mail, instant messages, or any other type of electronic communication to a receiving person, who is utilizing computer 102. The processes and methods described herein may be performed at the computer 102 and/or at the electronic message server 152.

The hardware elements depicted in computer 102 are not intended to be exhaustive, but rather are representative to highlight essential components required by the present disclosure. For instance, computer 102 may include alternate memory storage devices such as magnetic cassettes, digital versatile disks (DVDs), Bernoulli cartridges, and the like. These and other variations are intended to be within the spirit and scope of the present disclosure.

Presented herein is a computer implemented method, system and/or computer program product that automatically summarizes electronic message content and decides on an appropriate responsive action based on available contextual information. In one embodiment, this entails 1) parsing the content of the electronic message; 2) generating an executive summary (or a list of key words) of the electronic message, such as through the use of natural language processing; 3) identifying the appropriate individuals (e.g., according to an enterprise organization/reporting structure and/or an email thread history) to which a responsive action such as a follow-up meeting should take place; 4) parsing calendars, instant messaging statuses, communication preferences, and meeting attendee backups in case a primary attendee is not available; and 5) automatically creating an event (chat, phone call, another email, meeting . . . etc) and determining appropriate communication channels and participants to the event according to information from the executive summary.

With reference now to FIG. 2, an exemplary intelligent event analyzer (IEA) 202 is presented. In one embodiment, IEA 202 is a component of EMPP 148 shown in FIG. 1. IEA 202 interfaces with an electronic message interface (EMI) 206, which is coupled to an electronic message transmitter (e.g., electronic message server 152 shown in FIG. 1). Electronic messages from the electronic message transmitter (not shown) are presented in an electronic message user interface (UI) 204, and passed through EMI 206 to be parsed and interpreted by parsing/interpretation logic located within IEA 202. In one embodiment, this parsing/interpretation is performed by the use of natural language processing (NLP) 208. Natural language processing 208 uses universal syntax and interpretation rules to extract key features in an electronic message. Examples of such key features include, but are not limited to, a meeting suggestion, a request for assistance, a specific or general query to the recipient, etc. These extracted key features are further processed using event detection 210 (i.e., detecting that an event such as a business transaction, meeting, proposal, etc. has, is or will occur, or that such an event is being proposed); keyword expansion 212 (used to find synonyms or related terms to those used in the electronic message, in order to match such expanded terms to databases such as those found in a user profile key word 214); and time resolution 216 (used to coordinate meetings, etc. in various calendars). By using the information from elements 210-216, a smart event mapper 218 is able to retrieve information about the sender(s) and recipient(s) using organization contract retrieval 220 (i.e., information from a lightweight directory access protocol—LDAP map), which describes hierarchical business relationships among senders and recipients. The smart event mapper 218 also takes input from logic to analyze mail threads 222. This logic looks at the history of back-and-forth electronic communications in order to flush out the context and meaning of the latest e-mail. For example, if the latest e-mail was in response to another string of e-mails related to “Customer A”, then if the latest e-mail simply refers to “the customer”, the logic to analyze mail threads 222 will inform the smart event mapper 218 that any generated event will relate to “Customer A”, even though “Customer A” was not identified in the latest e-mail. Calendars coordination for an event (i.e., a meeting) is handled by calendar retrieve and communication channel backup 224, which schedules attendees, determines first and second choices for how the meetings will occur (i.e., videoconference, chat session, face-to-face and in person, etc.), who will attend, etc.

An executive summary and/or recommend event logic (ESREL) 226 provides two functions. First, ESREL 226 provides an executive summary that give a summary and/or key words describing a particular e-mail from the electronic message UI 204. For example, the e-mail may have a subject title of “Customer A's complaint.” However, NLP 208 has determined, by contextually examining the body of the e-mail message, that the e-mail is really about correcting an internal hardware issue, which does not involve Customer A at all. ESREL 226 is generated from this evaluation, and is used to 1) provide the e-mail recipient a quick overview of what the e-mail is actually about, regardless of the subject title; and 2) to enable IEA 202 in recommending a responsive event, such as a meeting, buying new hardware, etc.

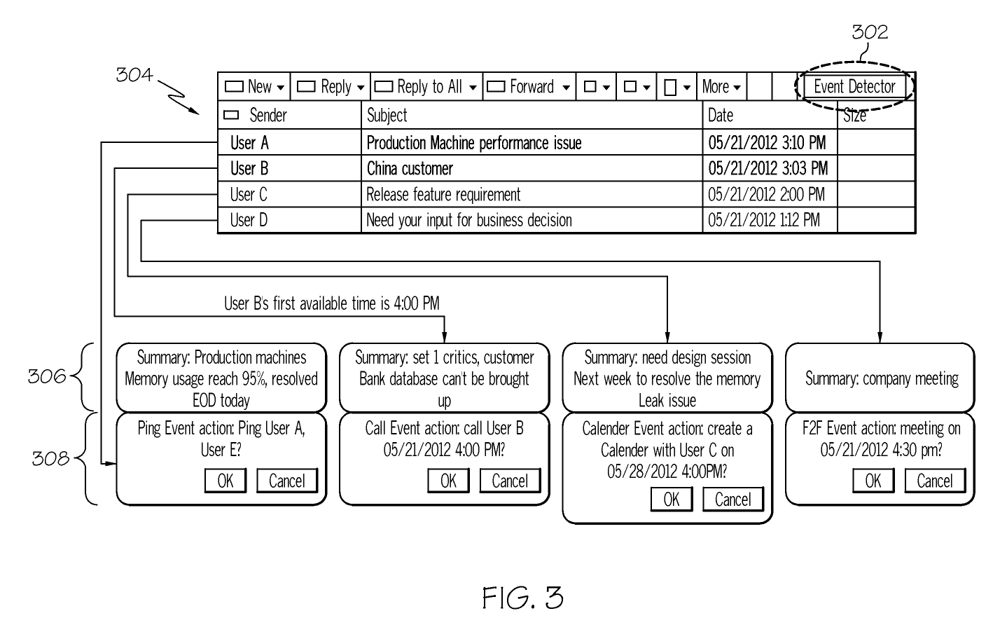

With reference now to FIG. 3, additional detail is shown for how executive summaries and recommended events to e-mails are presented in an exemplary embodiment. FIG. 3 shows a UI 304, which is analogous to the electronic message UI 204 shown in FIG. 2. When a user clicks event detector button 302, a series of executive summaries 306 and recommended events 308 is automatically generated and displayed to the recipient of the e-mails shown in UI 304. The recipient of the e-mails is thus able to 1) decide, based on the executive summaries 306, which e-mails are important; and 2) accept or reject the recommended events 308 that have been automatically generated.

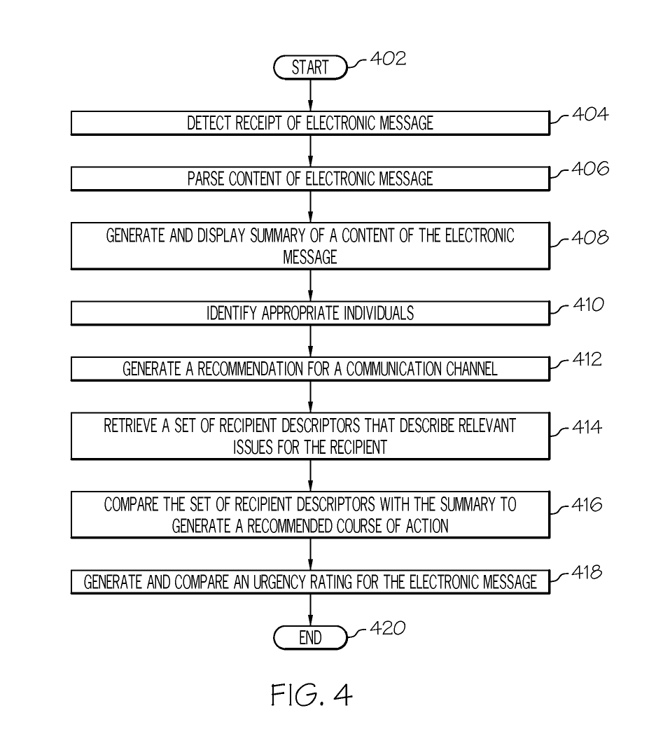

With reference now to FIG. 4, a high level flow chart of exemplary steps taken to manage responses (e.g., events) to electronic messages (e-mails, instant messages, etc.) is presented. After initiator block 402, a computer detects a receipt of an electronics message by a recipient (block 404). This detection can be made by the receiving computer itself (e.g., computer 102 shown in FIG. 1), or it can be made by a remote computer, such as electronic message server 152 shown in FIG. 1. The computer parses the information from the electronic message (block 406). In one embodiment, Natural Language Processing (NLP) leverages the key words from the user profile, his job responsibility, as well as organization structure to infer a set of major key words. Based on these key words, NLP consults a word association (such as an electronic thesaurus) to expand the second degree key words to extract the executive summary. The set of key words can also include event oriented key words, such as schedule a meeting, take action, finish by end of day (EOD), next week, to do list, and critics, etc. NLP is consulted to detect whether there is a possible event in the content. An event can be an aggregated entity of the following entities: a) date or date concept (can be an exact date format or a general date concept, such as today, next week, next Monday, etc.); b) location; c) title; d) action. When the NLP detects that there is a possible event with the “date concept” entity, the engine can resolve the relative time. For example, if the email timestamp is May 21, 2012 and the “date concept” detected in NLP is next week, smart event mapper 218 (shown in FIG. 2) will suggest May 28, 2012. Such logic can also use NLP's aggregated rules to extract the paragraph or the topic sentence as the executive summary. In addition, a specific user can provide the key words for NLP to detect, in order to identify that user's special interest domains.

The computer then generates a summary of the content of the electronic message based on information parsed from the electronic message (block 408). This summary, referenced herein as an executive summary, may be a short description of the electronic message, or an even more abbreviated list of key words from or descriptive of the electronic message. In one embodiment, the summary is generated, and optionally displayed, to the recipient before the electronic message is opened by the recipient, thus reducing the need for the recipient to read or even open the electronic message if the summary reflects that the electronic message is unimportant to the recipient.

As depicted in block 410, appropriate individuals for an event are identified. In one embodiment, this is done based on the LDAP structure (shown in element 220 of FIG. 2) and the person's availability. In one embodiment, this list is limited to the immediate organization or reporting structure of the electronic message sender and receiver. In another embodiment, the list describes relationships between persons within an enterprise (e.g., a product supplier) and/or persons within the enterprise and persons (e.g., customers) outside that enterprise. The process reference in block 410 can also include analyzing the previous email thread to analyze the participants in the email list, cc list and classify the participants into three categories. The first category is “must involve”: by default the sender should involve. However, NLP can also detect content such as “invite X, Y, Z in the meeting”. In this case, the list will also include X, Y, Z. The second category is “should involve”: by default the contact listed in the cc list will be classified as “should involve”. Upon analyzing the email exchange thread, if a person at some point initializes an email exchange, then he is potentially classified as “should involve”. The third category is “could involve”: by default, if a person is always in the cc list and never initiates an email exchange, he will be classified as “could involve”. By combining the information gleaned during the process referenced in block 410 with information derived by the process referenced in block 408 (i.e., the executive summary of the electronic message), a recommendation is made for the event type using a particular communication channel, as depicted in block 412. These communication channels may be for a responsive e-mail, an in person meeting, a teleconference, etc. Alternatively, the communication channels may include logic and communication means to achieve some other event/activity, such as purchasing equipment, changing personnel organizations, etc. Examples of such events and the channels they use include, but are not limited to:

A) Create a calendar event: this event is created/utilized if the NLP detects the key words pattern containing “create a calendar event” or other key words such as “schedule a meeting”, then such a meeting will be scheduled on a future date according to the context of the message.

B) Create a chat event: this event is created/utilized if the sender's reporting structure is a peer structure and urgent event.

C) Create a phone event: this event is created/utilized if the NLP detects event key words that suggest a phone event, such as when the sender is a business partner.

D) Create a face to face meeting: this event is created/utilized if the sender's organization status is higher than the receiver and the NLP detects urgent key words, such as “see me ASAP” or “contact me immediately”, etc. Alternatively, users can define the context of responding event.

E) Open the electronic message; this event is initiated if the receiver, after reading the executive summary, decides that the electronic message is worthy of her time/attention. Alternatively, the event may be “Do not open the electronic message,” if the receiver deems the electronic message unworthy of her time/attention.

As described in block 414, recipient descriptors can be utilized to determine what event is created (i.e., a recommended course of action). These recipient descriptors describe relevant issues for the recipient. Examples of such relevant issues include, but are not limited to, predefined interests of the recipient (e.g., hobbies or personality traits of the recipient, which might suggest that a face to face meeting is preferable to a phone call); and/or predefined job duties of the recipient (e.g., the recipient is working on Project X with other team members in a distant country, indicating that e-mail is likely the best responsive event, due to the difference in time zones). In any embodiment, comparing the set of recipient descriptors with the executive summary can generate a recommended course of action (event). That is, by only comparing known key features about the recipient with key words from the executive summary, a responsive event can be quickly and accurately suggested (block 416). Furthermore, the executive summary can be transmitted to another party, such that the other party also has a copy of the executive summary in order to know what the event relates to. For example, after the recipient of the original e-mail generates an executive summary about that original e-mail, the recipient can send an invitation to a teleconference to the sender of the original e-mail and/or other parties. Depending on various factors (i.e., their job title, security clearance, role in a particular project, etc.), one or more of the invitees to the teleconference may receive a copy of the executive summary along with their invitation to the teleconference. This copy of the executive summary provides the invitees a quick reference source, in order to decide if they wish to participate in the planned teleconference.

As described in block 418, an urgency rating for the original electronic message can be generated and displayed to the recipient of the original electronic message. This urgency rating is based on a comparison of the content of the electronic message with the predefined job duties of the recipient. For example, if the recipient is working on Project X, and the parsing of the content of the electronic message indicates that the message is related to Project X, then a high urgency rating can be generated and displayed at the recipient's message UI. This approach eliminates the need for the sender to classify the urgency level of the electronic message, since this urgency is automatically highlighted at the recipient's computer. In another embodiment, the urgency level is based on a relationship between the sender and the recipient of the electronic message (i.e., an electronic message from a boss may be deemed to be more urgent than an electronic message from a friend). In one embodiment, the user has an option to override a traditional urgency system to rely completely on the present disclosure. For example, assume that a sender has marked an electronic message as urgent. In one embodiment, this urgent flag is overridden if the process described herein determines that the electronic message is in fact not urgent, then the urgent flag is automatically removed, both at the recipient's computer as well as the sender's computer. The process ends at terminator block 420.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of various embodiments of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Note further that any methods described in the present disclosure may be implemented through the use of a VHDL (VHSIC Hardware Description Language) program and a VHDL chip. VHDL is an exemplary design-entry language for Field Programmable Gate Arrays (FPGAs), Application Specific Integrated Circuits (ASICs), and other similar electronic devices. Thus, any software-implemented method described herein may be emulated by a hardware-based VHDL program, which is then applied to a VHDL chip, such as a FPGA.

Having thus described embodiments of the disclosure of the present application in detail and by reference to illustrative embodiments thereof, it will be apparent that modifications and variations are possible without departing from the scope of the disclosure defined in the appended claims.

What is claimed is:

1. A computer implemented method to manage responses to electronic messages, said computer implemented method comprising:
a computer detecting a receipt of an electronic message by a recipient;
the computer generating a summary of a content of the electronic message, wherein the summary describes a need for a meeting between the recipient and an other party; and
the computer generating a recommendation for a communication channel for the meeting between the recipient and the other party.

2. The computer implemented method of claim 1, further comprising:
retrieving a set of recipient descriptors, wherein the set of recipient descriptors describes relevant issues for the recipient; and
comparing the set of recipient descriptors with the summary to generate the recommendation for the communication channel for the meeting between the recipient and the other party.

3. The computer implemented method of claim 2, wherein the relevant issues for the recipient are based on predefined job duties of the recipient.

4. The computer implemented method of claim 3, further comprising:
the computer generating an urgency rating for the electronic message, wherein the urgency rating is generated by comparing the content of the electronic message with the predefined job duties of the recipient.

5. The computer implemented method of claim 2, wherein the relevant issues for the recipient are based on predefined interests of the recipient.

6. The computer implemented method of claim 1, wherein the other party is a sender of the electronic message.

7. The computer implemented method of claim 1, further comprising:
generating an urgency rating for the electronic message, wherein the urgency rating is based on a business relationship between the recipient and a sender of the electronic message.

8. The computer implemented method of claim 1, further comprising:
generating the summary to the recipient before the electronic message is opened by the recipient.

9. The computer implemented method of claim 1, wherein the computer is a server that is remote to a receiving computer that receives the electronic message.

10. A computer system comprising:
a central processing unit; and
a memory coupled to the central processing unit, wherein the memory comprises software that, when executed, causes the central processing unit to implement:
detecting a receipt of an electronic message by a recipient;
generating a summary of a content of the electronic message, wherein the summary describes a need for a meeting between the recipient and an other party; and
generating a recommendation for a communication channel for the meeting between the recipient and the other party.

11. The computer system of claim 10, wherein the software, when executed, further causes the central processing unit to implement:
retrieving a set of recipient descriptors, wherein the set of recipient descriptors describes relevant issues for the recipient; and
comparing the set of recipient descriptors with the summary to generate the recommendation for the communication channel for the meeting between the recipient and the other party.

12. The computer system of claim 11, wherein the relevant issues for the recipient are based on predefined job duties of the recipient.

13. The computer system of claim 12, wherein the software, when executed, further causes the central processing unit to implement:
generating an urgency rating for the electronic message, wherein the urgency rating is generated by comparing the content of the electronic message with the predefined job duties of the recipient.

14. The computer system of claim 10, wherein the software, when executed, further causes the central processing unit to implement:
generating an urgency rating for the electronic message, wherein the urgency rating is based on a business relationship between the recipient and a sender of the electronic message.

15. The computer system of claim 11, wherein the summary is generated before the electronic message is opened by the recipient.

16. A computer program product comprising:
a computer readable storage medium having computer readable program code embodied therewith, the computer readable program code comprising:
computer readable program code to detect a receipt of an electronic message by a recipient;
computer readable program code to generate a summary of a content of the electronic message, wherein the summary describes a need for a meeting between the recipient and an other party; and
computer readable program code to generate a recommendation for a communication channel for the meeting between the recipient and the other party.

17. The computer program product of claim 16, wherein the computer readable program code further comprises:
computer readable program code configured to retrieve a set of recipient descriptors, wherein the set of recipient descriptors describes relevant issues for the recipient; and
computer readable program code configured to compare the set of recipient descriptors with the summary to generate the recommendation for the communication channel for the meeting between the recipient and the other party.

18. The computer program product of claim 17, wherein the relevant issues for the recipient are based on predefined interests of the recipient.

19. The computer program product of claim 16, wherein the computer readable program code further comprises:
computer readable program code configured to generate an urgency rating for the electronic message, wherein the urgency rating is based on a business relationship between the recipient and a sender of the electronic message.

20. The computer program product of claim 16, wherein the summary is generated before the electronic message is opened by the recipient.
